(19) United States
(12) Patent Application Publication
(10) Pub. No.: US 2017/0070564 A1
(43) Pub. Date: Mar. 9, 2017

(54) AUTOMATIC ADDRESSING METHOD IN AN ETHERNET COMMUNICATION ARCHITECTURE

(71) Applicant: Schneider Electric Industries SAS, Rueil-Malmaison (FR)

(72) Inventors: Stephane SINISTRO, Lyon (FR); Eric SUPTITZ, Montaud (FR)

(73) Assignee: Schneider Electric Industries SAS, Rueil-Malmaison (FR)

(21) Appl. No.: 15/212,635

(22) Filed: Jul. 18, 2016

(30) Foreign Application Priority Data
Sep. 4, 2015 (FR) 15 58198

(51) Int. Cl. H04L 29/08; H04L 29/12

(52) U.S. Cl. CPC H04L 67/10; H04L 61/2015; H04L 61/6068; H04L 61/6022

(57) ABSTRACT

A method of configuration by a server module of several client modules connected together via an Ethernet communication network of daisy-chain type is provided. Each client module includes an Ethernet switch fitted with a first communication port and with a second communication port, in such a way that the first port of a first client module is connected to a communication port of the server module and that the first port of another client module is connected to the second port of an adjacent client module. The method includes for each client module an initialization step in which the client module activates its first port and deactivates its second port, an identification step in which the client module communicates with the server module via its first port for receiving an identifier, and an end-of-configuration step in which, once its identifier has been received, the client module activates its second port.

### TECHNICAL FIELD OF THE INVENTION

The present invention pertains to a procedure for automatic configuration of addressing in a communication architecture comprising devices communicating with one another via an Ethernet communication network of daisy-chain type, that is to say that the devices are connected in cascade (or in tandem).

A relevant field of application is for example the modular architecture of a remote-control station in an MV/LV sub-station of an electrical distribution network (MV: Medium Voltage, LV: Low Voltage). Such a remote-control station generally comprises various different functional modules that can ensure functions for measuring voltage/current at MV or LV equipment level, functions for monitoring quality and managing the electrical network, functions for fault detection, for command/control of equipment, etc.

### PRIOR ART

This type of modular architecture (or modular RTU—Remote Terminal Unit) can also comprise a central server module in charge on the one hand of effecting a communication interface with a centralized supervision system and on the other hand of managing various MV or LV client functional modules.

The modules are, for example, physically placed in an adjacent manner on a DIN rail. The server module is placed at the head and the client modules are arrayed alongside one another. A difficulty with this type of modular architecture is the ability to configure the various client modules in a simple manner, that is to say to assign each module a physical address (which is its position on the array of the DIN rail) and then associate an IP address with it so that the server module can retrieve the physical configuration of the array.

Existing protocols (such as DHCP, DPWS, DNS, etc.) already exist which make it possible to assign IP addresses or unique names to each module, nonetheless the recording of the physical position of the module requires a human operation (pressing a button on the module during the commissioning phase, turning on an LED to recognize the whereabouts of the module which corresponds to such and such an MAC address, reading on a label and copying into a Web page of the MAC address of the module, etc.).

Other documents, such as in particular FR2641629, U.S. Pat. No. 6,688,910, U.S. Pat. No. 8,791,646, already describe automatic or semi-automatic procedures for address allocation and identification on a communication network. These procedures are not always simple and require for example the existence of a unique electronic serial number in each client module, an electrical measurement to determine the physical position of a client module, a counting of pulsations to ascertain the number of connected modules, etc. Moreover, document U.S. Pat. No. 7,139,839 provides for a communication bus between the various modules but also provides for a distinct addressing bus, with the aim of being able to automatically assign an identifier (for example an MAC address) to each client module.

Document US2009213763 describes a procedure for assigning IP addresses to client modules connected in a ring network to a server module, in a non-sequential manner. Documents U.S. Pat. No. 5,914,957 and WO0308599 describe a configuration procedure in which the server must take the initiative to configure each client module one by one.

The aim of the invention is therefore to propose a very simple and flexible automatic configuration procedure without the drawbacks cited and which allows a server module, on completion of a commissioning phase, to ascertain the whole set of connected client modules present, their physical position/address on the array as well as their identification (IP address or MAC address).

The procedure according to the invention can advantageously be used during a first configuration of the architecture. Moreover, this procedure allows easier and faster management of the replacement of a faulty client module and the addition of a further client module in the communication network, since it is the client modules which take the initiative in asking the server module for an identifier.

### DISCLOSURE OF THE INVENTION

This aim is achieved with the aid of a method of configuration by a server module of several client modules, the client modules and the server module being connected together via an Ethernet communication network of daisy-chain type. Each client module comprises an Ethernet switch fitted with a first communication port and with a second communication port, in such a way that the first port of a first client module is connected to a communication port of the server module and that the first port of another client module is connected to the second port of an adjacent client module. The method comprises, for each client module:
An initialization step in which the client module activates its first port and deactivates its second port,
An identification step in which the client module sends, via its first port, a discovery request to the server module with the aim of receiving an identifier from the server module,
An end-of-configuration step in which, once its identifier has been received, the client module activates its second port.

During the identification step, the client module sends a discovery request to the server module. Preferentially, in the absence of response from the server module, the client module periodically sends a discovery request to the server module. According to an embodiment, the requests comply with the DHCP standard.

The invention also relates to a remote-control system of an electrical distribution network comprising a server module and several client modules connected together via an Ethernet communication network of daisy-chain type, the remote-control system being adapted for implementing such a method of configuration. The invention also relates to a client module comprising an Ethernet switch having two communication ports, the client module being able to be inserted into a remote-control system to implement such a method of configuration.

It is seen that the procedure relies on an asymmetric use of the two communication ports of the Ethernet switch of the client modules, thereby making it possible to identify each client module sequentially through the server module. Indeed, as long as an identifier is not allocated to a client module, the latter does not activate its second communication port, thus not allowing the client modules situated downstream to exchange with the server module.

### BRIEF DESCRIPTION OF THE FIGURES

Other characteristics and advantages will become apparent in the detailed description which follows in conjunction with the appended drawings in which:

FIG. 1 represents an exemplary architecture of a remote-control system comprising a server module and four client modules,

FIGS. 2, 3 and 4 show successive phases of the method of configuration implemented in the architecture of FIG. 1.

### DETAILED DESCRIPTION OF AN EMBODIMENT

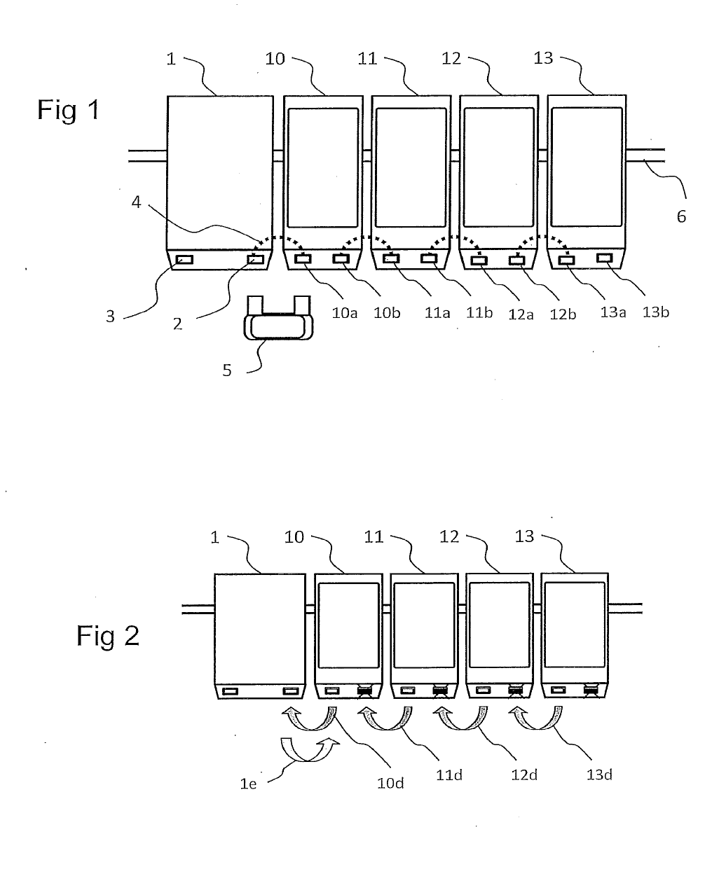

With reference to FIG. 1, a remote-control system comprises a server module 1 and a plurality of client modules. The various modules are connected together by an IP (Internet Protocol) Ethernet communication network with a physical connection of daisy-chain type 4, that is to say that the modules are connected in cascade (or in tandem). Each client module 10, 11, 12, 13 possesses an Ethernet switch which is furnished with two communication ports, called first port and second port hereinafter in the document. The first ports are called 10a, respectively 11a, 12a and 13a and the second ports are called 10b, respectively 11b, 12b and 13b. The Ethernet switch of a client module is capable of routing the messages between the first port and the second port and vice versa.

All the modules are linked together physically by a connection apparatus 5 which makes it possible to very easily connect and disconnect each module with its adjacent neighbour or neighbours (that is to say its preceding neighbour and its following neighbour). According to a particular embodiment, the connection apparatus has the form of a U-shaped jumper 5 and comprising two connectors for example of RJ45 type hooked up by a cable. In FIG. 1, a single jumper 5 has been represented for simplification reasons, but obviously a jumper also exists between the ports 10b and 11a, between 11b and 12a and between 12b and 13a.

In a simple manner, the modules 1, 10, 11, 12, 13 can be strung out in a chain alongside one another and for example fixed on a DIN rail 6, the server module 1 being placed at an end of the chain. Thus, a communication port 2 of the server module 1 is connected with the first port 10a of the first client module 10, placed alongside the server module 1. The server module 1 can also comprise one or more other communication ports 3, to connect to a central supervisor or computer.

The second port 10b of the first client module 10 is hooked up to the first port of the client module 11 adjacent to the module 10. Thus, the second ports of all the client modules 10, 11, 12, 13 are connected to the first ports of the following client module in the chain, provided obviously that such a following client module exists. Likewise, the first ports of the client modules 11, 12, 13 other than the first client module 10 are connected to the second port of a preceding client module.

In the example of FIG. 1, the first client module 10 is placed alongside the server module and, during the configuration method, it will therefore automatically be allocated the physical address 1 corresponding to its physical position on the array. Likewise, the client module 11, placed alongside the module 10, will be allocated the physical address 2, and so on and so forth the client module 12 the physical address 3, the client module 13 the physical address 4. Indeed, given the cascade mode of connection, the client module 10 will be the first to exchange with the server module 1 during the configuration method, then the module 11, etc. Preferentially, for each new client module the server module 1 increments the physical address to be allocated.

A modular architecture such as this is very simple to implement and can thus easily comprise a large number of modules hooked up in this manner, for example 24 modules.

Advantageously, when replacing a faulty client module 12 for example, the control system wilt relaunch the configuration method in such a way that the physical address 3 can very simply be allocated to the new replacement module 12 automatically, without needing an intervention on this replacement module. Likewise when the control system has to add a new functional client module.

The method of configuration runs as follows:

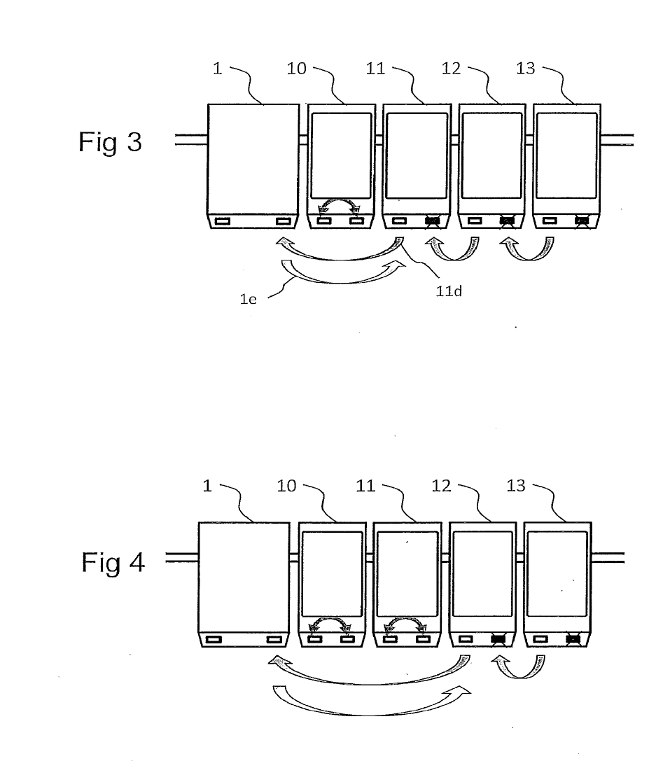

FIG. 2 represents the first step of the method of configuration, termed the initialization step, in which all the client modules 10, 11, 12, 13 place themselves in a non-configured state, activate their first port 10a, 11a, 12a, 13a and deactivate their second port 10b, 11b, 12b, 13b (deactivated port: indicated in black in the figures). Given the daisy-chain communication network architecture, this means that on startup only the first client module 10 is able to exchange with the server module 1. The other client modules cannot do so, since the second port 10b of the first module 10 is deactivated.

After this initialization step, the client modules 10, 11, 12, 13 pass to an identification step in which the client modules try to communicate with the server module 1 through their first port 10a, 11a, 12a, 13a with the aim of receiving an identifier from the server module 1.

Accordingly, the identification step exhibits two possible variants:

a) according to a first variant, the client modules 10, 11, 12, 13 send a discovery request (for example of DHCP Discovery type) 10d, 11d, 12d, 13d to the server module which is in “listening” mode. If the server module receives such a request, it then responds to the client module that sent the discovery request through an offer request 1e (for example of DHCP Offer type).

If a client module sending a discovery request does not receive any response from the server module after a certain predetermined time, then it periodically re-sends its discovery request 10d, 11d, 12d, 13d and remains in the identification step.

b) according to a second variant, it is no longer the client modules that periodically initiate the exchanges with the server module 1, but the server module 1 that regularly sends an offer request (for example of DHCP Offer type) over the communication network. If it receives a response to this request, this means that there is still at least one client module to be configured on the network.

This second variant makes it possible to avoid the need for the client modules to continually send discovery requests needlessly, as long as they are not actually able to converse with the server module, but makes it more complicated to replace a faulty client module or to add a new client module.

When a client module receives an offer request from the server module 1 and this client module is not in the configured state, then it responds to the server module 1 through a request, for example of the DHCP Request type and the server module 1 will then be capable of returning to the client module a recognition request (of the DHCP ACK type) which allocates it an identifier, this identifier comprising a physical address and an IP address, as well as optional other parameters.

When a client module is thus allocated an identifier by the server module 1, it then passes to a so-called end-of-configuration step in which it positions itself in configured mode and activates its second communication port. Thus, the following client module in the chain will then be able to begin to exchange with the server module 1 since the server module 1 will be able to receive its discovery request.

In FIG. 3, it is thus seen that the client module 10, having received an identifier, is in the configured state and has activated its second port 10b, thereby henceforth allowing the client module 11 adjacent to the module 10 to communicate with the server module 1. The latter can therefore receive a discovery request 11d of the client module 11 and transmit to it an offer request 1e, the Ethernet switch of the client module 10 henceforth being capable of routing the messages.

In FIG. 4, the server 1 has been able to allocate an identifier to the client module 11, which has henceforth activated its second port 11b so as to allow exchanges between the server 1 and adjacent client module 12.

When the server module 1 no longer receives any discovery request originating from client modules 10, 11, 12, 13, or when it no longer receives any response to an offer request, this means that all the client modules are configured 10, 11, 12, 13 and have activated their second communication port, thus ending the method of configuration.

Optionally, LED telltales representative of the activated/deactivated state of each communication port of a module allow a user to follow in a simple manner where the method for configuration of a remote-control system is up to.

1-6. (canceled)

7. A method of configuration by a server module of several client modules, the client modules and the server module being connected together via an Ethernet communication network of daisy-chain type, each client module comprising an Ethernet switch fitted with a first communication port and with a second communication port, in such a way that the first port of a first client module is connected to a communication port of the server module and that the first port of another client module is connected to the second port of an adjacent client module, the method comprising, for each client module:
initializing, in which the client module activates its first port and deactivates its second port;
identifying, in which the client module sends, via its first port, a discovery request to the server module with the aim of receiving an identifier from the server module; and
end of configuring, in which, once its identifier has been received, the client module activates its second port.

8. The method of configuration according to claim 7, wherein, during the identifying and in the absence of response from the server module, the client module periodically sends a discovery request to the server module.

9. The method of configuration according to claim 7, wherein the requests comply with the DHCP standard.

10. The method of configuration according to claim 7, wherein the identifier of a client module comprises an IP address and a physical address.

11. A remote-control system for an electrical distribution network comprising a server module and several client modules connected together via an Ethernet communication network of daisy-chain type,
wherein the remote-control system is adapted for implementing a method of configuration according to claim 7.

12. A client module of a remote-control system comprising an Ethernet switch fitted with a first communication port and with a second communication port,
wherein the client module is adapted for implementing a method of configuration according to claim 7.
